(19) United States
(12) Patent Application Publication
(10) Pub. No.: US 2019/0143574 A1
(43) Pub. Date: May 16, 2019

(54) SIMULTANEOUS LAMINATION AND BLOW-MOLDING PROCESS

(71) Applicants: Phillip W. Barth, Portola Valley, CA (US); Mateusz Bryning, San Jose, CA (US)

(72) Inventors: Phillip W. Barth, Portola Valley, CA (US); Mateusz Bryning, San Jose, CA (US)

(21) Appl. No.: 16/188,326

(22) Filed: Nov. 13, 2018

Related U.S. Application Data
(60) Provisional application No. 62/586,170, filed on Nov. 15, 2017.

(51) Int. Cl. B29C 49/00; B29C 49/28; B29C 49/48; B29C 49/64

(52) U.S. Cl. CPC B29C 49/0047; B29C 49/28; B29C 49/48; B29K 2101/12; B29C 2049/0057; B29C 2049/4856; B29C 49/64

(57) ABSTRACT

A process for laminating elements together to form an article having a predetermined shape including an interior cavity comprises: placing a first sheet atop a first die; placing a first pressure introduction port atop the first sheet; placing a second sheet atop the first port and atop the first sheet; placing a second die atop the second sheet; clamping the first sheet, first port, and second sheet between the first and second dies to form an assembly comprising first die, first sheet, pressure introduction port, second sheet, and second die; introducing an applied gas pressure between the first and second sheets of the assembly, via the first pressure introduction port; heating the assembly to a temperature at which the first and second sheets can thermally deform, thereby achieving simultaneous lamination and blow molding of the first and second sheets; and cooling the assembly, such that the article is created.

### CROSS REFERENCES TO RELATED APPLICATIONS

This application claims priority from U.S. Provisional Patent Application Ser. No. 62/586,170, entitled “Simultaneous Lamination and Blow-Molding Process”, filed on Nov. 15, 2017, which is hereby incorporated by reference as if set forth in full in this application for all purposes.

### BACKGROUND

Thermoforming is the use of heat to form thermoplastics into various shapes. Thermoforming processes are ubiquitous in industry, and thermoforming is a technical field with an extensive patent literature. Four thermoforming processes discussed herein are injection molding, blow molding, vacuum forming, and lamination.

Injection molding comprises flowing molten plastic into a mold under pressure, cooling the resulting shape in the mold, then opening the mold to release the shape. The injection molding process is useful for forming shapes without interior cavities, and for forming shapes with tapered interior cavities such as a tapered-walled drinking cup, but it is less useful for forming shapes with re-entrant interior cavities such as a bottle with a wide body and a narrow neck. It is important in injection molding that the mold shape around which a cavity is formed, also known as a mandrel shape, be extractable from the cavity after the molded article cools. Typically, the mandrel shape is tapered with a taper angle called a draft angle to enable it to be extracted easily from the molded article.

Blow molding is useful for forming shapes with re-entrant interior cavities such as a plastic beverage bottle with a wide body and a narrow neck. For the purposes of this disclosure a re-entrant cavity is defined as a cavity having interior surface features which cannot be touched by the tip of a thin, stiff, straight probe inserted into an opening of the cavity.

In blow molding, a cold workpiece with a tapered interior cavity which has previously been formed, for example by injection molding, is placed into a mold and is heated while a gas pressure is applied to the interior of the cavity. As the plastic softens under heating the interior gas pressure forces the interior cavity to expand and conform to the walls of the mold. The mold and workpiece are then cooled, the gas pressure is removed, and the resulting article is released from the mold.

Vacuum forming is a process whereby a plastic sheet part is heated and softened, then sucked by an applied vacuum into or over a mold shape. As with injection molding, the mold shape must then be capable of being separated from the part, requiring the mold shape to have an appropriate draft angle. When the part is cooled and released, it retains the shape of the mold.

Lamination is a process of joining together two or more sheets of material to form a single article. A lamination process may use a glue layer between adjacent plastic layers, or it may use the self-stickiness occurring between adjacent layers, especially when those layers are heated and softened to make them sticky. While the present disclosure discusses thermal lamination processes, other lamination processes exist, for example the making of plywood by gluing together thin sheets of wood.

Laminating together two layers which have pre-formed shapes in one or both layers is, in some cases, a useful technique. However, hot lamination of plastic sheets which have pre-formed shapes, for example shapes made by vacuum forming, can tend to soften and deform the pre-formed shapes. This is especially problematic when the preformed shapes comprise shallow features which can be drawn together and permanently deformed by the surface-tension forces between the sheets being laminated.

Laminated parts having shallow, reentrant interior cavities cannot be made purely by injection molding or other molding over a mandrel, or purely by blow molding, or purely by vacuum molding. For example, currently known techniques have problems in fabricating flow channels for peristaltic pumps, where the channels follow reentrant paths and have stiff, shallow, cross sections, with channel walls having a specific advantageous curved shape, and uniform thickness. Thus, there is a need for a fabrication technique which can more advantageously fabricate such channels.

### SUMMARY

The present invention includes a process for laminating a first element to a second element to form a single article having a predetermined shape including an interior cavity. In one embodiment, the process comprises: placing a first sheet atop a first die; placing a first pressure introduction port atop the first sheet; placing a second sheet atop the first pressure introduction port and atop the first sheet; placing a second die atop the second sheet; clamping the first sheet, first pressure introduction port, and second sheet between the first and second dies to form an assembly comprising first die, first sheet, pressure introduction port, second sheet, and second die; introducing an applied gas pressure between the first and second sheets of the assembly, via the first pressure introduction port; heating the assembly to a temperature at which the first and second sheets can thermally deform, thereby achieving simultaneous lamination and blow molding of the first and second sheets; and cooling the assembly, such that the single article having the predetermined shape including the interior cavity is created.

In some embodiments, the pressure introduction port may be removed or may remain between the two laminated sheets, as a component of the created article. In some embodiments, a second pressure introduction port is placed between the sheets prior to the assembly being heated, and either of the first or second ports may be removed or may remain between the two laminated sheets, as a component of the created article.

The present invention further includes an apparatus for performing simultaneous lamination and blow molding of two sheets of material to form a single article having a predetermined shape including an interior cavity. In one embodiment, the apparatus comprises: a lower die; an upper die; a first sheet; a second sheet; a pressure introduction port; a clamp; a gas pressure source; and a heater. In some embodiments, at least one of the first die and the second die contains a recess characterized throughout its profile by continuously varying curvature, determining, at least in part, a shape profile of the interior cavity of the single article. In some embodiments, at least one of the first die and the second die contains a recess characterized by a shape profile comprising a plurality of regions, a discontinuity of curvature occurring where one of the plurality of regions meets another of the plurality of regions.

### BRIEF DESCRIPTION OF THE DRAWINGS

FIG. 1 is a flowchart of a process according to one embodiment of the present invention.

FIG. 2 illustrates a bottom die used in one embodiment of the present invention.

FIG. 3 illustrates a bottom sheet of material to be laminated to a top sheet (not shown) in relation to the die of FIG. 2.

FIG. 4 illustrates pressure introduction ports in relation to the elements of FIG. 3.

FIG. 5 illustrates a top sheet of material to be laminated to the bottom sheet, in relation to the elements of FIG. 4.

FIG. 6 illustrates a top die in relation to the elements of FIG. 5.

FIG. 7 illustrates the elements of FIG. 6 at a late stage of a process according to one embodiment of the present invention.

FIG. 8 illustrates a cross section view taken at line A-A (at an earlier step than corresponds to FIG. 7) of a process according to one embodiment of the present invention.

FIG. 9 illustrates a cross section view taken at line A-A (at the step corresponding to FIG. 7) of a process according to one embodiment of the present invention.

FIG. 10 illustrates a cross section view taken at line A-A (at a step later than that corresponding to FIG. 9) of a process according to one embodiment of the present invention.

FIG. 11 illustrates a cross section view taken at line A-A (at a step later than that corresponding to FIG. 10) of a process according to one embodiment of the present invention.

FIG. 12 illustrates an article formed by simultaneous lamination and blow molding according to one embodiment of the present invention.

### DETAILED DESCRIPTION OF EMBODIMENTS

Embodiments described herein include a process for simultaneous lamination and blow-molding. Embodiments further include apparatus for performing simultaneous lamination and blow-molding.

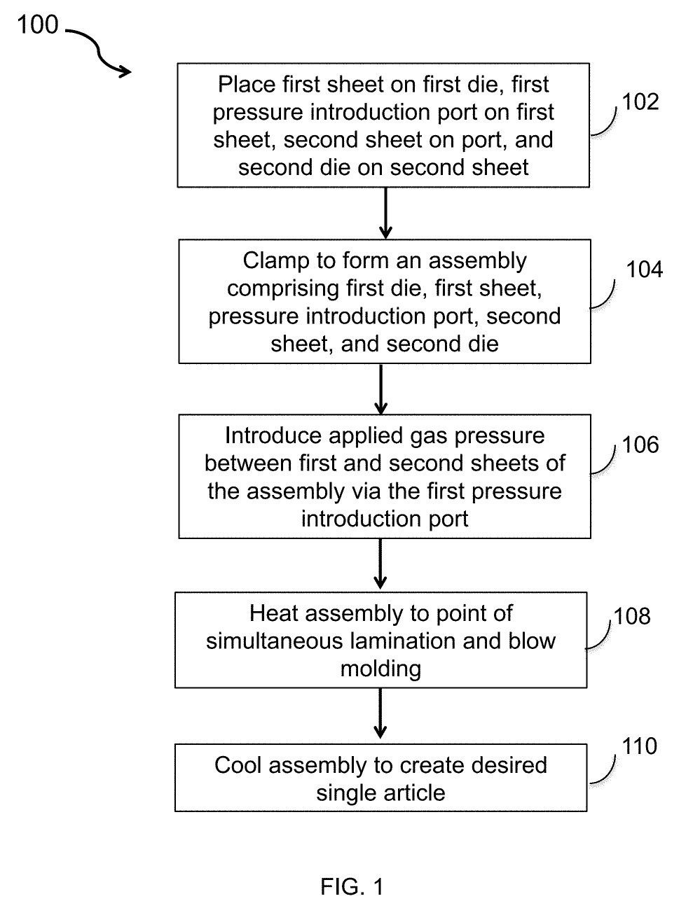

FIG. 1 is a flowchart showing the steps of a process 100 for simultaneous lamination and blow-molding, according to one embodiment of the present invention. At step 102, a first sheet is placed atop a first die, a first pressure introduction port is placed atop the first sheet, a second sheet is placed atop the first pressure introduction port and atop the first sheet, and a second die is placed atop the second sheet. At step 104, the first sheet, first pressure introduction port, and second sheet are clamped between the first and second dies to form an assembly comprising first die, first sheet, pressure introduction port, second sheet, and second die. At step 106, an applied gas pressure is introduced between the first and second sheets of the assembly, via the first pressure introduction port. At step 108, the assembly is heated to a temperature at which the first and second sheets can thermally deform, thereby achieving simultaneous lamination and blow molding of the first and second sheets. At step 110, the assembly is cooled, such that the single article having the predetermined shape including the interior cavity is created.

It will be appreciated that there may be some gas leakage out of the space between the two sheets during step 106, when gas pressure is first applied before heating occurs. The initial magnitude of applied pressure can be smaller early in the process, and then can increase later in the process after some initial sticking together of the two sheets has occurred during heating, in order to minimize any leakage which occurs.

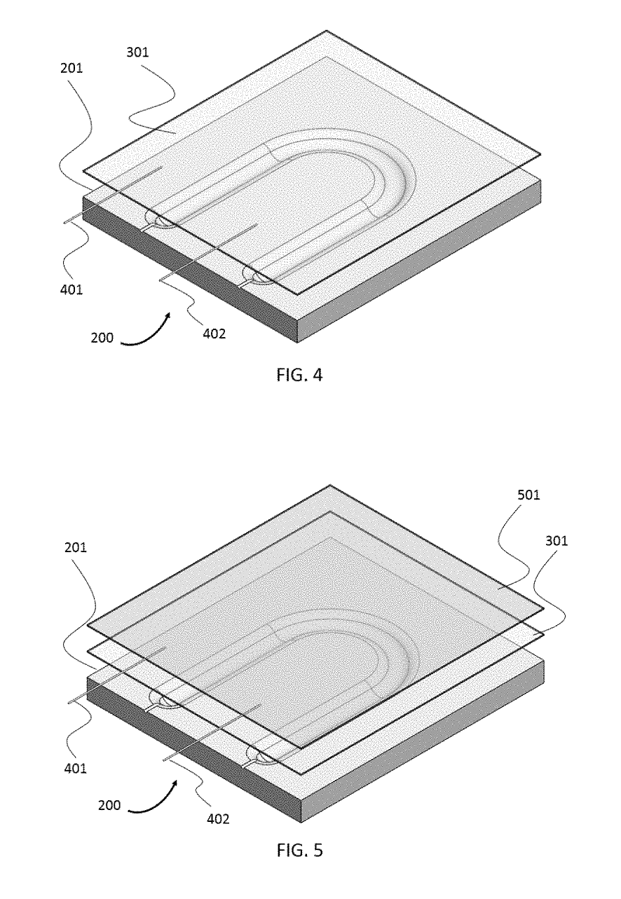

In some embodiments, a second pressure introduction port (see 402 in FIG. 4 described below) is used in addition to the first pressure introduction port. The second pressure introduction port would be inserted during an initial step (corresponding to step 102 in FIG. 1) prior to a clamping step (corresponding to step 104 in FIG. 1).

In some embodiments the cooling carried out in step 110 includes an active cooling method, such as water cooling. In some embodiments, passive cooling may be sufficient. In other embodiment, a combination of active and passive cooling may be used.

In some embodiments one or both of the dies contains pressure relief holes, not shown, to accommodate movement of gas, such as air or other gas, exterior to the expanding cavity, as that gas is displaced by the expansion of the cavity when pressure is introduced between the two sheets. In some embodiments one or both of the dies is made of a porous sintered material to accommodate movement of gas exterior to the expanding cavity as that gas is displaced by the expansion of the cavity when pressure is introduced between the two sheets. In some embodiments one or both of the dies contains pressure relief grooves, not shown, to accommodate the movement of gas along the surface of the die between that surface and an adjacent sheet, as that gas is displaced by the expansion of the cavity when pressure is introduced between the two sheets.

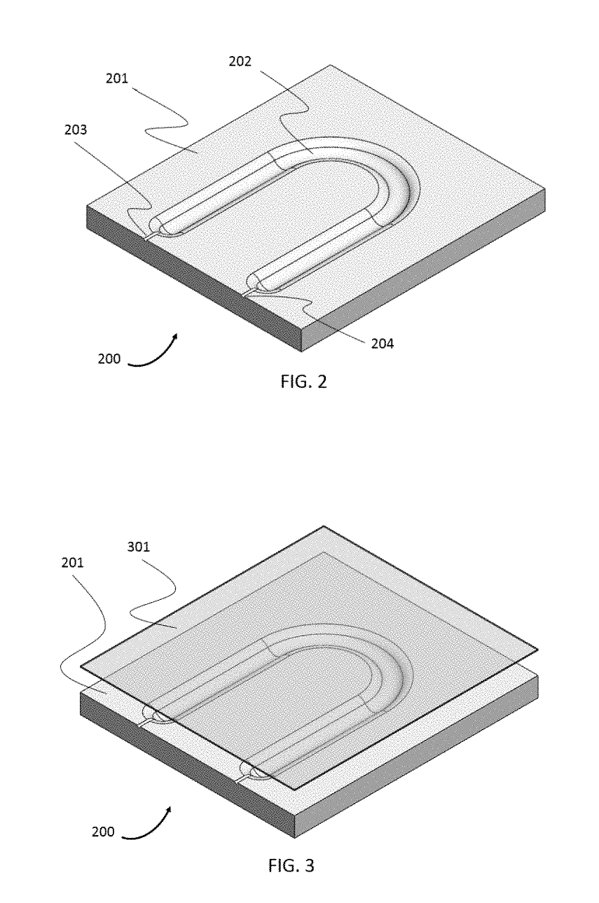

FIG. 2 illustrates a bottom die 201 of an apparatus 200 for performing simultaneous lamination and blow molding. Shallow recess 202 follows a U-shaped path on the top surface of the die, and recesses 203 and 204 provide for the later insertion of pressure introduction ports into the apparatus. Bottom die 201 typically comprises a material such as steel.

FIG. 3 illustrates a first sheet 301 of a material to be laminated, placed in position to be lowered atop die 201. Sheet 301 is shown as transparent, and in practice can be one of a transparent material, a translucent material, an opaque material, or a combination thereof. Sheet 301 can comprise a material such as polyvinyl chloride, polyether ether ketone, cyclic organic copolymer, or other thermoplastic material.

FIG. 4 illustrates pressure introduction ports 401 and 402 placed above one edge of sheet 301.

FIG. 5 illustrates second sheet 501 of material to be laminated, placed above pressure introduction ports 410 and 402. Sheet 501 is shown as transparent, and in practice can be one of a transparent material, a translucent material, an opaque material, or a combination thereof. Sheet 501 can comprise a material such as polyvinyl chloride, polyether ether ketone, cyclic organic copolymer, or other thermoplastic material.

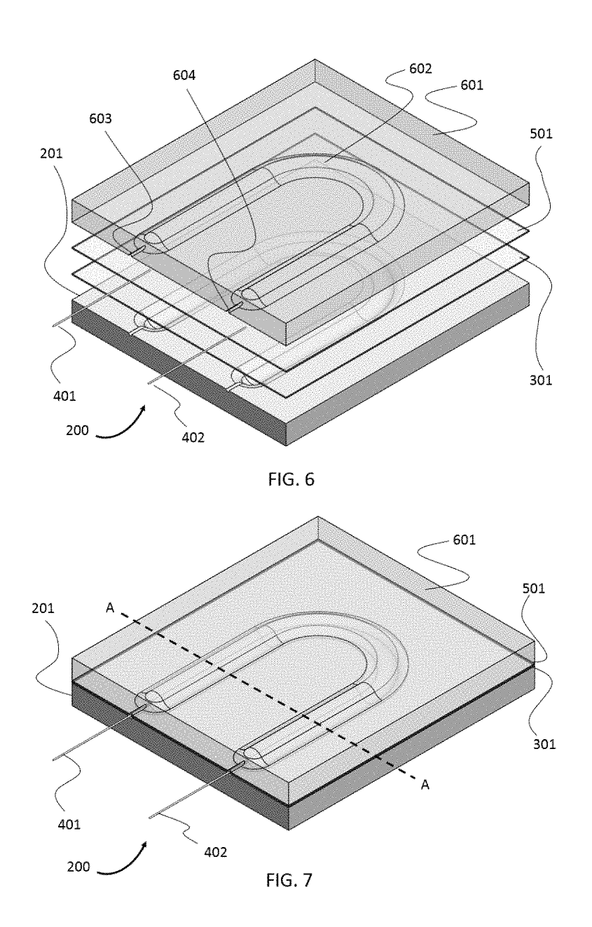

FIG. 6 illustrates upper die 601 having shallow recess 602 following a U-shaped path on the lower surface of the die. Recesses 603 and 604 provide for a later fit over pressure introduction ports 401 and 402. Upper die 601 is shown as transparent for illustration purposes, but typically comprises an opaque material such a steel.

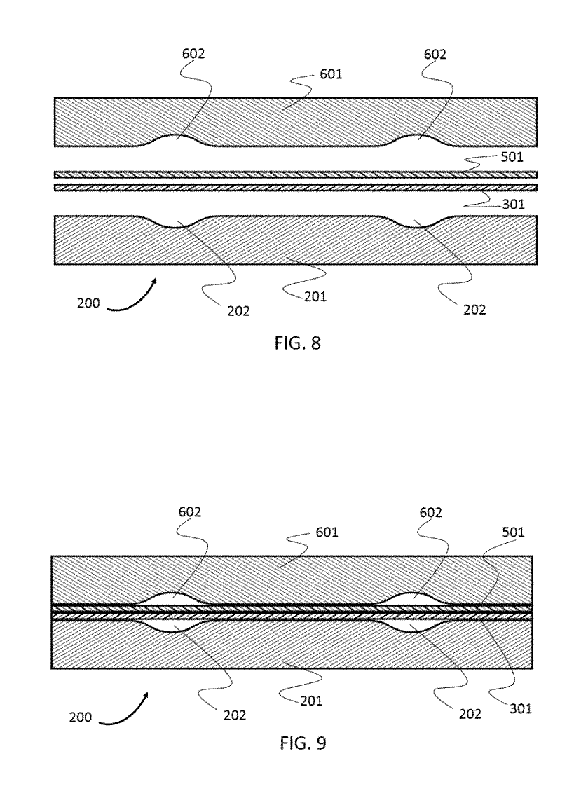

FIG. 7 illustrates the apparatus 200 when the components of the apparatus have been clamped together. Pressure ports 401 and 402 are clamped between sheets 301 and 501. Cross section line A-A indicates a region where cross sections illustrated in FIGS. 8 through 12 are taken, although each of FIGS. 8-12 shows apparatus 200 at different stages of the simultaneous lamination and blow molding process.

FIG. 8 illustrates a cross section taken at line A-A before components of the apparatus 200 are clamped into place. Shallow recess 202 in lower die 201 sits beneath sheet 301, while shallow recess 602 in upper die 601 sits above sheet 501.

The shape of the pressure introduction port or ports need not be a round tube as illustrated in FIGS. 4 through 8. For example, the shape of a pressure port can be designed to conform to the expected interior profile of the walls of the cavity to be blown during the fabrication process.

FIG. 9 illustrates a cross section taken at line A-A after components of the apparatus 200 are clamped into place. The lower surface of sheet 301 sits in contact with lower die 201, the upper surface of sheet 301 is in contact with the lower surface of sheet 501, and the upper surface of sheet 501 is in contact with the lower surface of upper die 601. Shallow recess 202 in lower die 201 and shallow recess 602 in upper die 601 are not yet occupied by portions of the sheets 301 and 501 respectively.

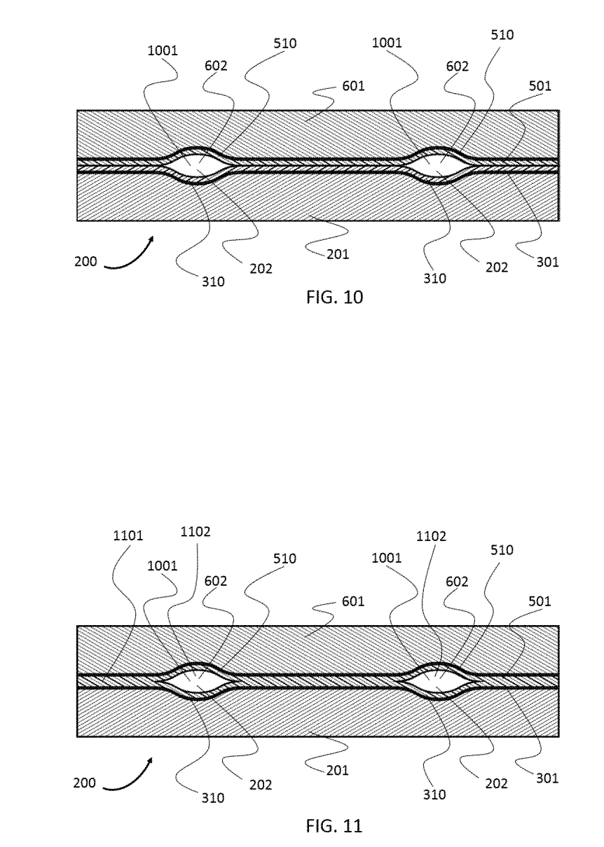

FIG. 10 illustrates a cross section taken at line A-A after components of the apparatus 200 are clamped into place, pressure has been introduced through pressure introduction ports 401 and 402, and some heating of the apparatus has occurred. Portion 310 of first sheet 301 has been forced downward by the introduced pressure and plastically deformed against the recess 202, while portion 510 of the second sheet has been forced upward by the introduced pressure and plastically deformed against the recess 602.

While the two sheets 301 and 501 are drawn in FIGS. 4, 5, 6, 8, and 9 as being flat, this flatness is not necessary. One of both of the two sheets 301 and 501 can have a curved area present, not shown, in a region later to become a wall of the cavity 1001 illustrated in FIG. 10. The curved area can be present before the sheet is introduced into the apparatus for bonding, the curved area serving to provide an initial gap between the two sheets 301 and 501 in the region to later comprise the cavity 1001 so that the gas pressure applied after clamping has some initial open volume to enter to aid in the blow-molding aspect of the invention.

FIG. 11 illustrates a cross section taken at line A-A after the components of the apparatus 200 are clamped into place, pressure has been introduced through pressure introduction ports 401 and 402, and additional heating of the apparatus has occurred. The upper surface of the first sheet 301 has fused with the lower surface of the second sheet 501 in the regions where they were in contact to form a laminated article 1101 containing a blow-molded cavity volume 1102.

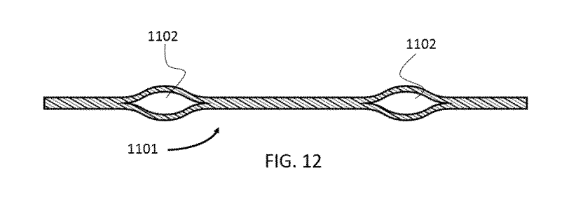

FIG. 12 illustrates laminated article 1101 at a cross section taken at line A-A after the apparatus 200 is cooled, clamping force is removed, gas pressure is removed, and the laminated article 1101 is removed from the apparatus 200. Cavity area 1102 within article 1101 has walls which conform to the shape of the recesses 202 and 602 in the apparatus 200, allowing, of course, for typical snap-back effects which occur in thermoforming after mold release.

Apparatus 200 used in the invention comprises a lower die 201, an upper die 601, a pressure introduction port 401, a clamp (not shown, as any one of various types of clamp well known in the art could be used) a source of gas pressure (not shown, as such sources are well known in the art) and a heater (not shown, as any one of various types of heater well known in the at could be used). The clamp could, for example, be a hydraulic press having clamping platens. The heater could, for example, comprise electrical cartridge heaters within the clamping platens of a hydraulic press.

In some embodiments, apparatus 200 used in the invention can include an active cooler, for example using water cooling via flow channels in the clamping platens of a hydraulic press.

In some embodiments, apparatus 200 used in the invention can include locator holes in one of both of the sheets 301 and 501 to be laminated, and locator pins in one or both of the dies 201 and 601, and locator holes in one or both of the dies 201 and 601. The use of other alignment means known in the art is also possible without departing from the scope and spirit of the invention.

Recessed regions 202 and 602 illustrated in FIGS. 2-12 are drawn as having smooth curvature conforming to the desired shape of the portions 310 and 510 forming the lower and upper walls of cavity 1102, but this smooth curvature is not needed in all cases.

For example, a die may have a recessed region, not shown, similar to region 202, can have a rectangular profile comprising two vertical sidewalls and a flat bottom. The portion 310 of the lower sheet 301, if not softened excessively by heating, can be blown into such a rectangular-profile recess in a not-fully-conforming manner wherein the portion 310 is stopped by the flat bottom of the recessed region while the blown portion retains a smoothly curving profile, rather than being blown in a fully-conforming manner to form a rectangular profile.

Similarly, a different recessed region, not shown, similar to region 202, can have a trapezoidal cross section comprising a flat bottom and two symmetric slanting sidewalls. The portion 310 of the lower sheet 301, if not softened excessively by heating, can be blown into such a trapezoidal-profile recess in a not-fully-conforming manner wherein the portion 310 is stopped by the flat bottom of the recessed region and the slanting sidewalls of the recessed region while the blown portion retains a smoothly curving profile, rather than being blown in a fully-conforming manner to form a trapezoidal profile.

Similarly, a different recessed region, not shown, similar to region 202, can have a deep cross section such that the portion 310 of the lower sheet 301, if not softened excessively by heating, can be blown into such a deep recess in a not-fully-conforming manner, wherein the portion 310 does not make contact with the surface of the recessed region, while the blown portion retains a smoothly curving profile, rather than being blown in a fully-conforming manner.

The process of introducing gas pressure between the two sheets to be bonded can comprise supplying a gas at a pressure higher than ambient pressure, or can comprise lowering the pressure around the apparatus by supplying a partial vacuum around the apparatus with respect to ambient pressure supplied between the two sheets, or can comprise some combination of supplying a pressure higher than ambient pressure between the two sheets and lowering the pressure around the apparatus.

In some embodiments, a recess such as 202 or 602 may be absent from one of dies 201 and 601.

Descriptive language in this disclosure and in associated claims refers to an apparatus in the orientations shown in FIGS. 2 through 12, using terms such as upper, lower, top, bottom, lateral, vertical, width, and height, but that language is a convenience for purposes of description and explanation of flow channels in those particular orientations, and is not limiting of the invention, nor is the orientation chosen a limitation of the invention.

It will be appreciated that the process steps are set forth below in claim 1 and the claims dependent therefrom in a descriptive order that is useful for tutorial purposes, but that the order of process steps may be varied without departing from the scope and spirit of the invention. For example, a first sheet could be lightly adhered to a first die, and a second sheet lightly adhered to a second die, before the two dies are placed against each other, with sheet surfaces in contact, before one or more pressure introduction ports are inserted between the sheet surfaces, and clamping (and subsequent steps) are carried out as described above. As another example, a pressure port may be introduced between the edges of two sheets which have been lightly adhered together by a piercing and separating action which places it atop a first sheet and beneath a second sheet.

Other process variations may readily be envisaged, that should be considered as encompassed in the spirit of the invention disclosed herein. For example, two sheets to be laminated may be lightly adhered together before being introduced between the first and second dies, with the first pressure introduction port being introduced either before or after the adhesion, before the clamping and subsequent steps.

Embodiments described herein provide various benefits. In particular, embodiments provide for fabrication of laminated parts having shallow cavities which are difficult or impossible to fabricate by prior-art means,

Although the description has been described with respect to particular embodiments thereof, these particular embodiments are merely illustrative, and not restrictive. It will also be appreciated that one or more of the elements depicted in the drawings/figures can also be implemented in a more separated or integrated manner, or even removed or rendered as inoperable in certain cases, as is useful in accordance with a particular application.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

I claim:

1. A process for laminating a first element to a second element to form a single article having a predetermined shape including an interior cavity, the process comprising:
placing a first sheet atop a first die;
placing a first pressure introduction port atop the first sheet;
placing a second sheet atop the first pressure introduction port and atop the first sheet;
placing a second die atop the second sheet;
clamping the first sheet, first pressure introduction port, and second sheet between the first and second dies to form an assembly comprising first die, first sheet, pressure introduction port, second sheet, and second die;
introducing an applied gas pressure between the first and second sheets of the assembly, via the first pressure introduction port;
heating the assembly to a temperature at which the first and second sheets can thermally deform, thereby achieving simultaneous lamination and blow molding of the first and second sheets; and
cooling the assembly, such that the single article having the predetermined shape including the interior cavity is created.

2. The process of claim 1, additionally comprising:
removing the applied gas pressure;
unclamping the assembly; and
removing the single article.

3. The process of claim 1, additionally comprising placing a second pressure introduction port atop the first sheet after the first sheet is placed atop the first die and before the second sheet is placed atop the first sheet.

4. The process of claim 1, additionally comprising leaving a pressure introduction port in place between the two sheets.

5. The process of claim 1, additionally comprising removing a pressure introduction port from between the two sheets.

6. The process of claim 1, additionally comprising placing a second pressure introduction port between the two sheets, at least one of the first and second pressure introduction ports having an exterior shape which conforms to a desired interior profile shape of the cavity.

7. The process of claim 1, wherein cooling the assembly comprises actively cooling the assembly

8. The process of claim 1, wherein at least one of the first and second sheets includes locator holes.

9. The process of claim 1, wherein at least one of the lower and upper dies includes locator pins.

10. The process of claim 1, wherein at least one of the lower and upper dies includes locator holes.

11. An apparatus for performing simultaneous lamination and blow molding of two sheets of material to form a single article having a predetermined shape including an interior cavity, the apparatus comprising:
a lower die;
an upper die;
a first sheet;
a second sheet;
a pressure introduction port;
a clamp;
a gas pressure source; and
a heater.

12. The apparatus of claim 11, wherein at least one of the first die and the second die contains a recess characterized throughout its profile by continuously varying curvature, determining, at least in part, a shape profile of the interior cavity of the single article.

13. The apparatus of claim 11, wherein at least one of the first die and the second die contains a recess characterized by a shape profile comprising a plurality of regions, a discontinuity of curvature occurring where one of the plurality of regions meets another of the plurality of regions.

14. The apparatus of claim 13, wherein the shape profile is one of rectangular and trapezoidal.

15. The apparatus of claim 11, additionally comprising a cooler.

16. The apparatus of claim 11, wherein at least one of the first and second sheets includes locator holes.

17. The apparatus of claim 11, wherein at least one of the lower and upper dies includes locator pins.

18. The apparatus of claim 11, wherein at least one of the lower and upper dies includes locator holes.

19. The apparatus of claim 11, additionally comprising a second pressure introduction port.
